(19) United States
(12) Patent Application Publication
(10) Pub. No.: US 2021/0237171 A1
(43) Pub. Date: Aug. 5, 2021

(54) GROOVING TOOL FOR CONNECTING ROD AND BREAKING-PROMOTION-PORTION FORMING DEVICE

(71) Applicant: MAZDA MOTOR CORPORATION, Hiroshima (JP)

(72) Inventor: Yuki YAMASAKI, Aki-gun (JP)

(73) Assignee: MAZDA MOTOR CORPORATION, Hiroshima (JP)

(21) Appl. No.: 17/073,762

(22) Filed: Oct. 19, 2020

(30) Foreign Application Priority Data
Jan. 31, 2020 (JP) 2020-014661

(51) Int. Cl. B23B 29/04; B23B 27/04

(52) U.S. Cl. CPC B23B 29/043; B23B 27/04

(57) ABSTRACT

A grooving tool configured to form a substantially V-groove shaped breaking promotion portion for breaking and splitting a large end part of a connection rod at the large end part along a cutting direction, comprising a rough-machining blade to cut a peripheral surface of a penetrating hole provided at the large end part, a finishing blade to finish a portion cut by the rough-machining blade, and a support member supporting the rough-machining blade and the finishing blade in order along a direction opposite to the cutting direction, wherein the rough-machining blade is configured such that a height h1 of its blade tip from a bottom face of a first cutting-blade attachment portion is lower than a height h2 of a blade tip of the finishing blade which is made of a higher-hardness material than the rough-machining blade.

### BACKGROUND OF THE INVENTION

The present invention relates to a grooving tool for a connecting rod which is configured to form a breaking promotion portion for breaking and splitting a large end part of the connection rod by a broaching method, for example, and a breaking-promotion-portion forming device of the connecting rod.

A reciprocating engine comprises a connecting rod which connects a crankshaft and a piston. This connecting rod comprises a small end part into which a piston pin of the piston is inserted and a large end part into which a pin journal of the crankshaft is inserted, which are provided at both ends of the connecting rod. The large end part of the connecting rod comprises a rod section which is connected to the small end part at its other end and a cap section which is fastened to the rod section.

A cracking method is known as a manufacturing method of the connection rod like this. In this cracking method, a substantially V-groove shaped breaking promotion portion is formed at a peripheral surface of a penetrating hole provided at the large end part of the connecting rod by means of a grooving tool for the connecting rod, and this large end part is broken and split at the breaking promotion portion, whereby the large end part of the connecting rod is broken and split into the rod section and the cap section (see Japanese Patent Laid-Open Publication No. 2014-114938).

In this cracking method disclosed in the above-described patent document, it is preferable that the breaking promotion portion be cut by the grooving tool for the connecting rod so that the substantially V-groove shape formed through cutting is so sharp (acute). Herein, a cutting blade of the grooving tool for the connecting rod is gradually worn away at its tip when being repeatedly used. When the wear of the cutting-blade tip has been promoted, it becomes difficult to form the properly-sharp substantially V-groove shape of the breaking promotion portion, so that there is a concern that the large end part of the connecting rod may not be broken and split properly.

Accordingly, it is required that the cutting blade of the grooving tool for the connecting rod is exchanged periodically. However, since a frequent exchange of the cutting blade causes an increase of manufacturing costs, the cutting blade having a longer lifecycle is required.

### SUMMARY OF THE INVENTION

The present invention has been devised in view of the above-described matter, and an object of the present invention is to provide a grooving tool for a connecting rod and a breaking-promotion-portion forming device of the connection rod which can improve the wear resistance of the cutting blade and form the properly-sharp substantially V-groove shaped breaking promotion portion stably.

The present invention is a grooving tool for a connecting rod which is configured to form a substantially V-groove shaped breaking promotion portion for breaking and splitting a large end part of the connection rod at the large end part along a cutting direction, comprising a first cutting blade to cut a peripheral surface of a penetrating hole provided at the large end part of the connecting rod, a second cutting blade to finish a portion cut by the first cutting blade, and a support member supporting the first cutting blade and the second cutting blade in order along a direction opposite to the cutting direction, wherein the first cutting blade is configured such that a height of a blade tip thereof from a specified level point of the support member which is substantially parallel to the cutting direction is lower than that of the second cutting blade, and the second cutting blade is made of a higher-hardness material than the first cutting blade.

Herein, the above-described “cutting direction” is a direction of cutting the peripheral surface of the penetrating hole provided at the large end part of the connecting rod, which means an insertion direction of the grooving tool into the penetrating hole. The above-described “specified level point” of the support member means a surface of the support member which is substantially parallel to the cutting direction, an axial center, which extends in the cutting direction, of a substantially-columnar support member, or the like.

According to the present invention, the wear resistance of the cutting blade can be improved and the properly-sharp substantially V-groove shaped breaking promotion portion can be formed stably. Specifically, the grooving tool for the connecting rod is provided with the first cutting blade and the second cutting blade for finishing and thereby the cutting amount of the second cutting blade can be reduced by the first cutting blade, so that a load applied to the tip of the second cutting blade can be suppressed. Herein, since the second cutting blade is made of the higher-hardness material, the wear of the second cutting blade can be effectively suppressed.

Additionally, since the height of the blade tip of the first cutting blade is lower than that of the second cutting blade, the first cutting blade can be used as a cutting blade for performing rough machining against the peripheral surface of the penetrating hole provided at the large end part of the connecting rod. Accordingly, it is not necessary that the blade tip of the first cutting blade is configured to be of a taper shape according to the substantially V-groove shaped breaking promotion portion, but the first cutting blade can be of a substantially-trapezoidal shape, when viewed from the cutting direction, for example.

Thus, the grooving tool for the connecting rod according to the present invention can reduce the cutting amount of the first cutting blade properly, compared to the first cutting blade having the taper-shaped blade tip according to the substantially V-groove shaped breaking promotion portion, thereby suppressing the load applied to the blade tip of the first cutting blade. Thus, the grooving tool for the connecting rod can improve the wear resistance of the cutting blade and form the properly-sharp substantially V-groove shaped breaking promotion portion stably.

In an embodiment of the present invention, the first cutting blade comprises plural cutting blades having different blade-tip heights which become gradually higher along the direction opposite to the cutting direction.

According to this embodiment, the grooving tool for the connecting rod can cut the peripheral surface of the penetrating hole provided at the large end part of the connecting rod stepwise by means of the plural cutting blades.

Accordingly, the present grooving tool for the connecting rod can reduce the cutting amount of each of the plural cutting blades properly, compared to a case where the peripheral surface of the penetrating hole is cut by means of a single cutting blade. Thereby, the load applied to the blade tip of each of the plural cutting blades can be suppressed. Thus, the grooving tool for the connecting rod can further improve the wear resistance of the first cutting blade.

In another embodiment of the present invention, the plural cutting blades of the first cutting blade is divided into a group positioned in a specified range and another group positioned in another range than the specified range, the specified range is located on a leading side of the cutting direction such that a cutting blade positioned at the most leading side is included in the group positioned in the specified range, the number of cutting blades belonging to the group positioned in the specified range is at least a half of a total number of the plural cutting blades of the first cutting blade or more, the blade-tip heights of the cutting blades belonging to the group positioned in the specified range are configured such that an increasing degree of the blade-tip heights of the adjacent cutting blades located on the leading side of the cutting direction is substantially constant, and the blade-tip heights of the cutting blades belonging to the group positioned in the other range than the specified range are configured such that an increasing degree of the blade-tip heights of the adjacent cutting blades located on the leading side of the cutting direction is smaller than the increasing degree of the blade-tip heights of the adjacent cutting blades belonging to the group positioned in the specified range.

According to this embodiment, the cutting amount of each of the cutting blades belonging to the group positioned in the other range than the specified range can be reduced properly, compared to a case where the increasing degree of the blade-tip heights of the adjacent cutting blades belonging to the group positioned in the other range than the specified range is the same as that of the adjacent cutting blades belonging to the group positioned in the specified range. Thereby, the load applied to the taper-shaped cutting blades belonging to the group positioned in the other range than the specified range can be properly suppressed, compared to the cutting blades belonging to the group positioned in the specified range.

Moreover, since the load applied to the taper-shaped cutting blades belonging to the group positioned in the other range than the specified range is properly suppressed, the grooving tool for the connecting rod can suppress an improper increase of the cutting amount of the second cutting blade, which may be caused by the wear of the first cutting blade, for a long term even if this grooving tool is used frequently. Accordingly, the grooving tool for the connecting rod can further improve the wear resistance of the first cutting blade and the second cutting blade.

In another embodiment of the present invention, the first cutting blade is made of high-speed tool steel, and the second cutting blade is made of cemented carbide.

According to this embodiment, the grooving tool for the connecting rod can form the properly-sharp substantially V-groove breaking promotion portion further stably by means of the second cutting blade having the higher hardness than the first cutting blade.

Moreover, since the cutting amount of the second cutting blade is reduced by the first cutting blade, the wear of the second cutting blade can be suppressed further securely even if the second cutting blade is made of the cemented carbide which has the inferior toughness, compared to the high-speed tool steel. Accordingly, the grooving tool for the connecting rod can securely improve the wear resistance of the second cutting blade.

Further, the present invention is a breaking-promotion-portion forming device of the connecting rod which comprises the above-described grooving tool for the connecting rod, wherein the breaking-promotion-portion forming device further comprises a machine tool which comprises a work holding section to hold the large end part of the connecting rod and a tool holding section to hold the grooving tool for the connecting rod, the work holding section and the tool holding section being provided to face each other, and the breaking-promotion-portion forming device is configured to form the breaking promotion portion at the large end part of the connecting rod by once (one time) reciprocating any one of the work holding section and the tool holding section of the machine tool along the cutting direction.

According to the present invention, the breaking-promotion-portion forming device of the connecting rod can improve the wear resistance of the cutting blade and form the properly-sharp substantially V-groove shaped breaking promotion portion stably.

The present invention will become apparent from the following description which refers to the accompanying drawings.

### BRIEF DESCRIPTION OF THE DRAWINGS

FIGS. 1A and 1B are schematic diagrams schematically showing a connecting rod.

FIG. 2 is a schematic diagram schematically showing the connecting rod in a state before breaking.

FIG. 3 is a schematic diagram schematically showing a breaking-promotion-portion forming device.

FIG. 4 is an external-appearance perspective view of a grooving tool for the connecting rod.

FIG. 5 is a sectional view of the grooving tool for the connecting rod, which shows a vertical cross section of the grooving tool along its longitudinal direction.

FIG. 6 is an elevational view of a rough-machining blade and a finishing blade, which shows respective shapes of these blades.

FIG. 7 is an elevational view of the rough-machining blade and the finishing blade, which shows around respective blade tips of these blades.

FIG. 8 is an explanatory diagram explaining a height of the blade tip of the rough-machining blade.

### DETAILED DESCRIPTION OF THE INVENTION

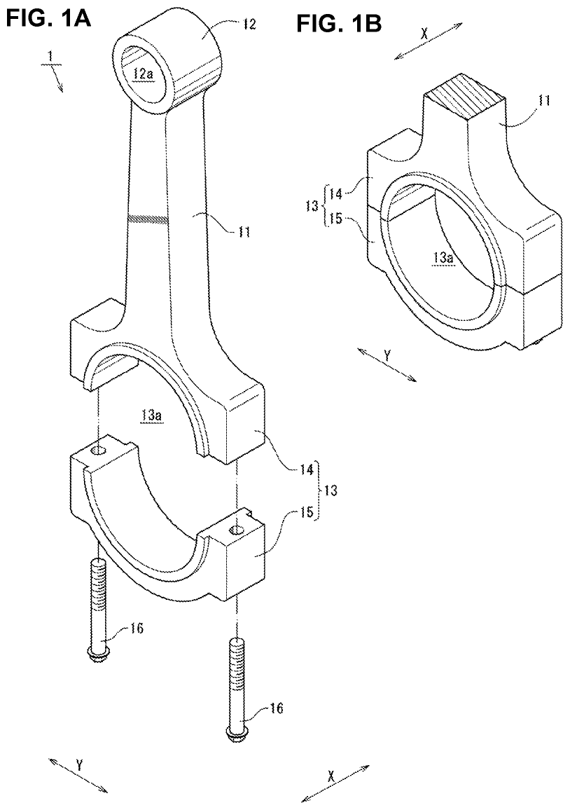

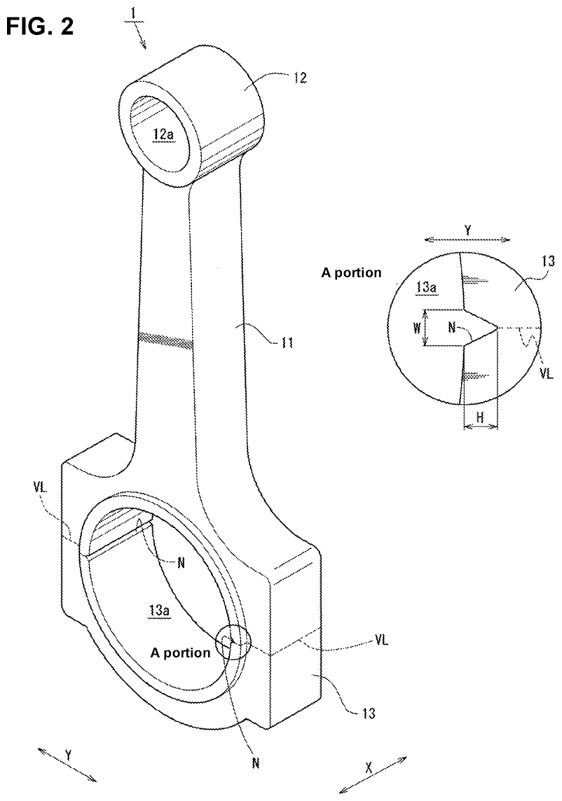

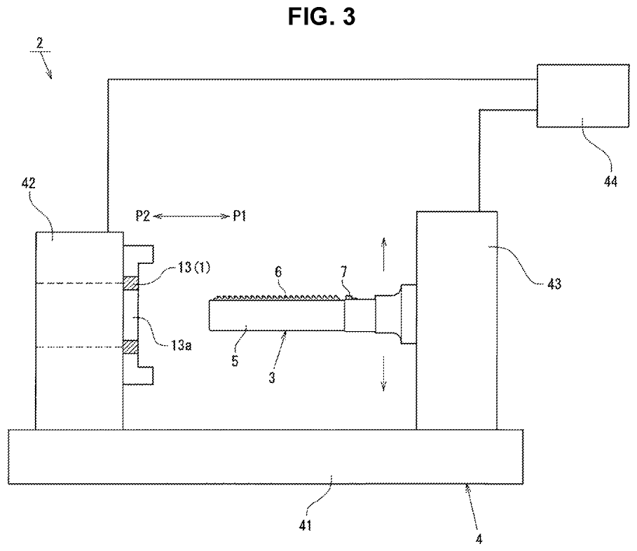

Hereafter, an embodiment of the present invention will be described referring to the drawings. In the present embodiment, a connecting rod of a reciprocating engine will be described referring to FIGS. 1A, 1B and 2 first. Then, a breaking-promotion-portion forming device of the connecting rod which forms a breaking promotion portion for braking and splitting a large end part of the connecting rod will be described referring to FIG. 3.

FIGS. 1A and 1B are schematic diagrams of a connecting rod 1, FIG. 2 is a schematic diagram of the connecting rod 1 in a state before breaking, and FIG. 3 is a schematic diagram of a breaking-promotion-portion forming device 2. FIG. 1A shows an exploded perspective view of the connecting rod 1, and FIG. 1B shows an external-appearance perspective view of a large end part 13 in a fastening state.

In FIGS. 1A, 1B, an arrow X shows a longitudinal direction (hereafter, referred to as a longitudinal direction X) of the connecting rod 1 which extends along an axial center of a crankshaft (an axial center of a penetrating hole 13a described later). Further, in FIGS. 1A, 1B, an arrow Y shows a width direction (hereafter, referred to as a width direction X) of the connecting rod 1 which is perpendicular to the longitudinal direction X in a plan view. Additionally, an upper side of FIGS. 1A, 1B is an upward side of the connecting rod 1, and a lower side of FIGS. 1A, 1B is a downward side of the connecting rod 1.

The connecting rod 1 is a metal-made connecting member which interconnects the crankshaft and a piston of the reciprocating engine, not illustrated. This connecting rod 1 comprises, as shown in FIGS. 1A, 1B, a connection part 11 which is configured such that its lower end is wider than its upper end and extends in a vertical direction, a small end part 12 which is provided at the upper end of the connection part 11, and a large end part 13 which is provided at the lower end of the connection part 11 and configured to be larger than the small end part 12.

The small end part 12 is a portion where the piston is connected via a piston pin (not illustrated). As shown in FIG. 1A, this small end part 12 has a penetrating hole 12a which penetrates the small end part 12 in the longitudinal direction X, and is of a nearly cylindrical shape extending in the longitudinal direction X. Herein, the penetrating hole 12a of the small end part 12 has a diameter which is large enough to accept the piston pin therein.

The large end part 13 is a portion where a pin journal (not illustrated) of the crankshaft is connected via a bearing metal (not illustrated). As shown in FIG. 1B, this large end part 13 is provided with a penetrating hole 13a which extends in the longitudinal direction X and has a diameter large enough to accept the bearing meatal supporting the pin journal therein.

Further, as shown in FIG. 1A, the large end part 13 is configured such that this part 13 can be broken and split into an upper section and a lower section at a center, in a radial direction, of the penetrating hole 13a. Specifically, the large end part 13 is configured to be broken and split into a body section 14 which is located above the center, in the radial direction, of the penetrating hole 13a and a cap section 15 which is located below the center, in the radial direction, of the penetrating hole 13a as shown in FIG. 1A.

As shown in FIG. 1A, the body section 14 of the large end part 13 is formed integrally with the connection part 11 and constitutes a rod section of the connecting rod 1 together with the small end part 12 and the connection part 11. Meanwhile, the cap section 15 of the large end part 13 is formed separately from the body section 14 and fixedly fastened to the body section 14 by fastening members 16 as shown in FIG. 1A.

As shown in FIG. 2, the cap section 15 of the large end part 13 is separated from the body section 14 by executing a vertical-direction breaking process of a cracking method from a state where the cap section 15 is integrated with the body section 14. Herein, as shown in FIG. 2, a breaking promotion portion N which comprises a pair of cutout grooves is formed at a peripheral surface of the penetrating hole 13a of the large end part 13 by a broaching method before breaking so that the cap section 15 can be separated along a split line VL illustrated by a broken line.

The breaking promotion portion N is, as shown in FIG. 2, formed at the peripheral surface of the penetrating hole 13a of the large end part 13 in a state before breaking at two points which face each other in the width direction Y, interposing the center, in the radial direction, of the penetrating holes 13a therebetween such that the breaking promotion portion N is located substantially at the split line VL illustrated by the broken line. Herein, as shown in FIG. 2, the breaking promotion portion N is formed over a range from a front end of the penetrating hole 13a to a rear end of the penetrating hole 13a.

Specifically, as shown in FIG. 2, the breaking promotion portion N is formed in a substantially V-groove shape in the elevational view such that a wide thereof becomes smaller as it goes toward an outward side, in the radial direction of the penetrating hole 13a, from the peripheral surface of the penetrating hole 13a and its outward tip is located substantially at the split line VL.

In the breaking promotion portion N, as shown in FIG. 2, a length thereof along the radial direction of the penetrating hole 13a is defined as a groove depth H, and a length of an cutout opening thereof along the vertical direction is defined as a groove width W.

Herein, a separation method of the large end part 13 provided with the above-described breaking promotion portion N will be described briefly. A half-split mandrel is engaged into the penetrating hole 13a provided at the large end part 13 in a state where the small end part 12 of the connecting rod 1 is held. Then, a tension load of the vertical direction is applied to the penetrating hole 13a such that the penetrating hole 13 is expanded in the vertical direction by driving (inserting) a wedge into the mandrel. Thereby, the large end part 13 in a state before breaking is broken along the split line VL at the breaking promotion portion N, thereby being split into the body section 14 and the cap section 15.

Next, the breaking-promotion-portion forming device 2 to form the substantially V-groove shaped breaking promotion portion N at the above-described large end part 13 of the connecting rod 1 will be described. The breaking-promotion-portion forming device 2 comprises a grooving tool 3 for the connecting rod 1 which is configured to cut the peripheral surface of the penetrating hole 13a provided at the large end part 13 of the connecting rod 1 and an automatic machine tool 4 which is configured to hold the connecting rod 1 and the grooving tool 3 for the connecting rod 1.

The grooving tool 3 is a cutting tool provided with plural cutting blades for forming the breaking promotion portion N at the penetrating hole 13a provided at the large end part 13. Herein, the grooving tool 3 will be described specifically later.

The automatic machine tool 4 is a machine tool, such as a machining center. This automatic machine tool 4 comprises, as shown in FIG. 3, a table 41, a work holding section 42 which holds the connecting rod 1 in a state before breaking, a tool holding section 43 which holds the grooving tool 3, a control section 44 which controls these member's performances, and others.

This automatic machine tool 4 is configured such that the work holding section 42 is provided at an upper surface of the table 41 so as to move substantially in parallel thereto and the tool holding section 43 is fixed to the upper surface of the table 41. Specifically, the work holding section 42 holds the large end part 13 in a state where the connecting rod 1 is arranged substantially horizontally. As shown in FIG. 3, the work holding section 42 is configured to be movable in an approaching direction P1 where the work holding section 42 approaches to the tool holding section 43 and in a separation direction P2 where the work holding section 42 comes to be separated from the tool holding section 43.

The tool holding section 43 is provided to face the work holding portion 42, and holds the grooving tool 3 which will be described specifically later. As shown in FIG. 3, the tool holding section 43 is configured to move the grooving tool 3 in the vertical direction.

In the above-described breaking-promotion-portion forming device 2, steps of the broaching method for the breaking promotion portion N which is formed at the large end part 13 of the connecting rod 1 will be described briefly. Herein, the work holding section 42 is located at a position which is separated (spaced apart), in the separation direction P2, from the tool holding section 43 in an initial stage. Further, the tool holding section 43 holds the grooving tool 3 such that the cutting blades project upwardly.

First, in a state where the work holding section 42 holds the connecting rod 1, the control section 44 controls to drive the grooving tool 3 in the vertical direction such that the grooving tool 3 is located at a cutting position where the peripheral surface of the penetrating hole 13a at the large end part 13 can be cut by this grooving tool 3.

Then, the control section 44 controls to drive the work holding section 42 holding the large end part 13 of the connecting rod 1 in the above-described approaching P1 such that a rear edge of the penetrating hole 13a comes to contact the cutting blade of the grooving tool 3.

After this, the control section 44 controls to further drive the work holding section 42 in the approaching direction P1, where cutting of the peripheral surface of the penetrating hole 13a by means of the cutting blades of the grooving tool 3 is started. After all of the cutting blades of the grooving tool 3 cut the peripheral surface of the penetrating hole 13a, the control section 44 controls to drive the grooving tool 3 slightly downwardly and drive the work holding section 42 in the separation direction P2 up to its initial position.

When forming of the breaking promotion portion N positioned at one of the above-described two points is completed, the control section 44 of the breaking-promotion-portion forming device 2 controls to rotate the grooving tool 3 upside down such that the cutting blades project downwardly, and then controls to adjust its vertical position. Then, the control section 44 controls to drive the work holding section 42 in the approaching direction P1, where the breaking promotion portion N positioned at the other one of the above-described two points is formed as well.

Thus, the breaking promotion portion N is formed at each of the two points of the large end part 13 by the breaking-promotion-portion forming device 2's cutting the peripheral surface of the penetrating hole 13a through one-time approaching movement of the connecting rod 1 to the grooving tool 3. In this case, the cutting direction of the peripheral surface of the penetrating hole 13a by means of the grooving tool 3 is a direction to make the grooving tool 3 approach to the connecting rod 1, which is the separation direction P2.

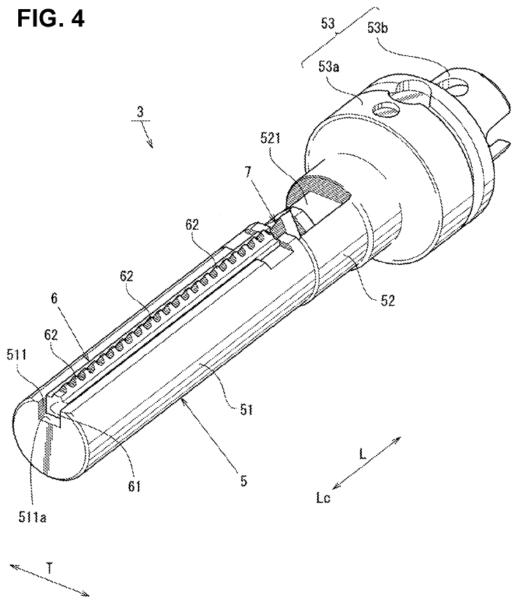

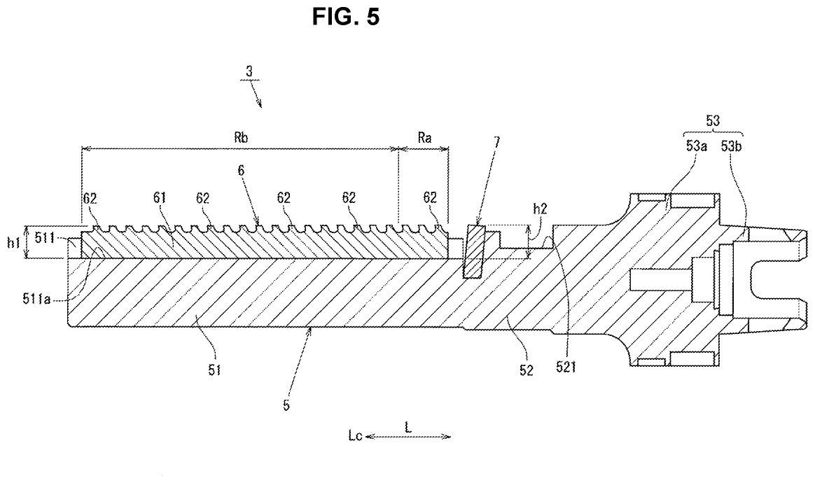

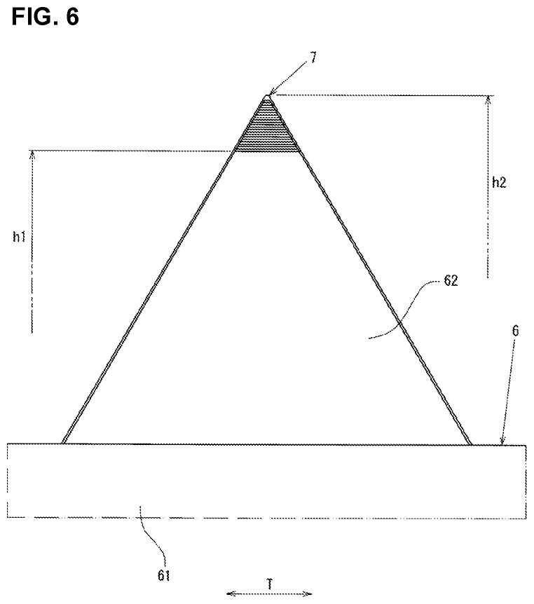

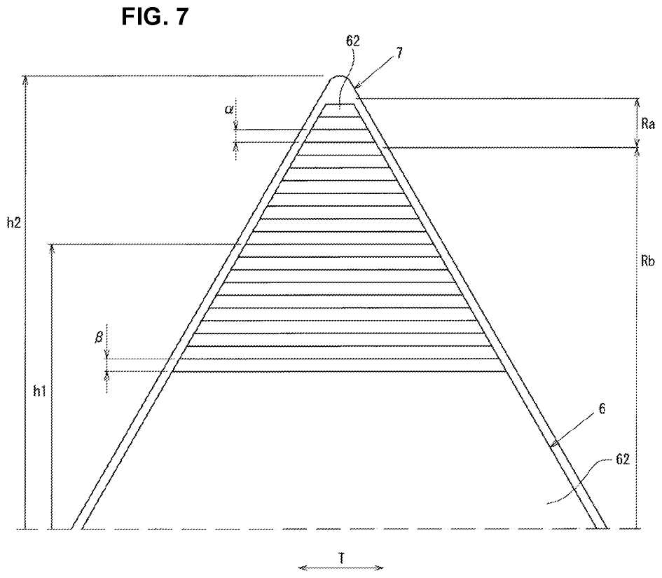

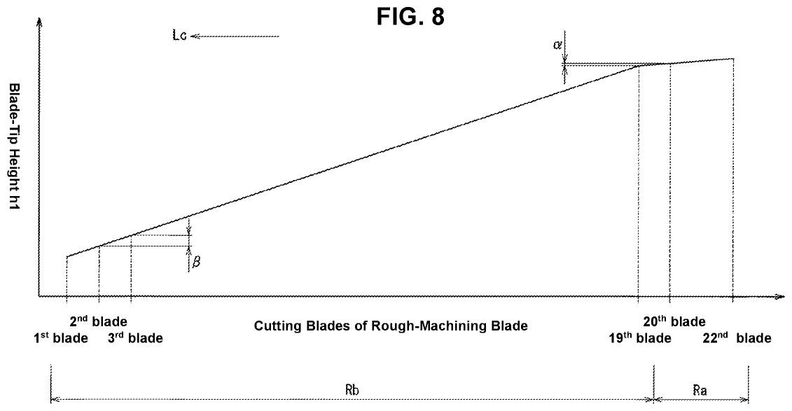

Subsequently, the above-described grooving tool 3 for the connecting rod 1 will be described specifically referring to FIGS. 4 through 8. FIG. 4 is an external-appearance perspective view of the grooving tool 3, FIG. 5 is a sectional view of the grooving tool 3, which shows a vertical cross section of the grooving tool 3 along its longitudinal direction L, and FIG. 6 is an elevational view of a rough-machining blade 6 and a finishing blade 7. Further, FIG. 7 is an elevational view of the rough-machining blade 6 and the finishing blade 7, which shows around respective blade tips of these blades 6, 7, and FIG. 8 is an explanatory diagram explaining a height h1 of the blade tip of the rough-machining blade 6.

In the figures, an arrow L shows the longitudinal direction L of the grooving tool 3 which is a direction along the approaching direction P1 and the separation direction P2, and an arrow T shows a short-length direction T of the grooving tool 3 which is a horizontal direction perpendicular to the longitudinal direction L when viewed from the longitudinal direction L. Further, an upper side of each figure is defined as the upward side and a lower side of each figure is defined as the downward side.

As shown in FIG. 4, the grooving tool 3 comprises a substantially-columnar support member 5 which is configured to extend in the longitudinal direction L, the rough-machining blade 6 to cut the peripheral surface of the penetrating hole 13a, and the finishing blade 7 to cut a portion which has been cut by the rough-machining blade 6.

The support member 5 comprises, as shown in FIG. 4, a first fixing portion 51 where the rough-machining blade 6 is fixed, a second fixing portion 52 where the finishing blade 7 is fixed, and a held portion 53 which is held by the tool holding section 43 of the breaking-promotion-portion forming device 2, which are arranged in order from a one-end side of the longitudinal direction L and formed integrally.

The first fixing portion 51 is of a substantially columnar shape extending in the longitudinal direction L as shown in FIG. 4. This first fixing portion 51 has a first cutting-blade attachment part 511 which is provided to be concaved, where the rough-machining blade 6 is attached as shown in FIG. 4.

Specifically, the first cutting-blade attachment part 511 is formed, as shown in FIG. 4, such that it is concaved downwardly from an outer peripheral surface of the first fixing portion 51 and it is of a substantially rectangular shape, when viewed from the longitudinal direction L. This first cutting-blade attachment part 511 is also formed, as shown in FIGS. 4 and 5, such that it extends from one end, in the longitudinal direction L, of the first fixing portion 51 to the other end and its bottom face 511a is a flat face substantially parallel to the longitudinal direction L.

The second fixing portion 52 is formed at the other-end side, in the longitudinal direction L, of the first fixing portion 51 as shown in FIG. 4. This second fixing portion 52 is of a substantially columnar shape extending in the longitudinal direction L, which has a slightly larger diameter than the first fixing portion 51.

Further, the second fixing portion 52 has a second cutting-blade attachment part 521 which is provided to be concaved, where the finishing blade 7 is attached as shown in FIGS. 4 and 5. Specifically, the second cutting-blade attachment part 521 is formed, as shown in FIGS. 4 and 5, such that it is concaved downwardly from an outer peripheral surface of the second fixing portion 52 and extends from one end, in the longitudinal direction L, of the second fixing portion 52 to the other end.

The held portion 53 is formed at the other-end side, in the longitudinal direction L, of the second fixing portion 52 as shown in FIG. 4. This held portion 53 comprises, as shown in FIGS. 4 and 5, a front part 53a having a larger diameter than the second fixing portion 52 and a rear part 53b having a smaller diameter than the front part 53a.

The rough-machining blade 6 is a so-called broach blade, which comprises plural cutting blades 62, as shown in FIG. 4, and is made of high-speed tool steel. This rough-machining blade 6 is formed separately from the support member 5 and fixed to the first cutting-blade attachment part 511 of the support member 5 by an appropriate method.

Specifically, as shown in FIGS. 4 and 5, the rough-machining blade 6 is of a substantially rectangular shape, when viewed from the longitudinal direction L, and comprises a substantially prismatic-columnar shaped base portion 61 which extends in the longitudinal direction L and the twenty-two cutting blades 62 which are provided to stand on an upper surface of the base portion 61, which are formed integrally.

As shown in FIGS. 4 and 5, the base portion 61 is of a substantially rectangular shape having a size corresponding to the first cutting-blade attachment part 511 of the support member 5, and this base portion 61 has a length, in the longitudinal direction L, thereof which is shorter than that of the first cutting-blade attachment part 511 of the support member 5.

Herein, the upper surface of the base portion 61, i.e., a blade groove bottom, is configured, as shown in FIG. 5, such that its height from the bottom face 511a of the first cutting-blade attachment part 511 is substantially constant and it is substantially parallel to the bottom face 511a of the first cutting-blade attachment part 511.

The twenty-two cutting blades 62 are provided to stand on the upper surface of the base portion 61 in the longitudinal direction L at specified intervals as shown in FIGS. 4 and 5. Herein, the twenty-two cutting blades 62 are configured to cut the peripheral surface of the penetrating hole 13a provided at the large end part 13 of the connecting rod 1 along the longitudinal direction L which is directed toward the first fixing portion 51 from the held portion 53 of the support member 5.

Herein, the longitudinal direction L which is directed toward the first fixing portion 51 from the held portion 53 of the support member 5, i.e., an approaching direction where the grooving tool 3 approaches to the connecting rod 1, is defined as a cutting direction Lc where the rough-machining blade 6 cuts the peripheral surface of the penetrating hole 13a. Further, the cutting blade 62 positioned at the most cutting-direction L side among the twenty-two cutting blades 62 is defined as a first cutting blade, the subsequent cutting blades positioned from this first blade in order along an opposite direction which is opposite to the cutting direction Lc are defined as a second cutting blade, a third cutting blade . . . , and the cutting blade 62 positioned at the most opposite-direction side among the twenty-two cutting blades 62 is defined as a twenty-second cutting blade.

As shown in FIG. 6, the first cutting blade 62 is formed in a substantially-trapezoidal shape with a longer lower side, when viewed from the cutting direction Lc. More specifically, the first cutting blade 62 is of the substantially-trapezoidal shape which has the lower side which is slightly shorter than the groove width W of the breaking promotion portion N and a pair of oblique sides which are nearly parallel to a pair of oblique surfaces of the breaking promotion portion N.

The second cutting blade 62 through the twenty-second cutting blade 62 are of the substantially-trapezoidal shape, when viewed from the cutting direction Lc, which respectively have the lower side having the same length as that of the first cutting blade 62 and the oblique sides having the same angle relative to the lower side as that of the first cutting blade 62. Each of the twenty-two cutting blades 62 is configured such that a length from the upper surface (blade groove bottom) of base portion 61 to the blade tip is shorter than the groove depth H of the breaking promotion portion N.

More specifically, the twenty-two cutting blades 62 are configured, as shown in FIGS. 5 and 7, such that the respective heights h1 from the bottom face 511a of the first cutting-blade attachment part 511 of the support member 5 to the respective blade tips (hereafter, referred to as the bade-tip heights) become gradually higher along the direction opposite to the cutting direction Lc.

That is, the twenty-two cutting blades 62 are configured such that the blade-tip heights h1 from the upper surface (blade groove bottom) of base portion 61 to the blade tips are lower than the groove depth H of the breaking promotion portion N and become gradually higher along the direction opposite to the cutting direction Lc. In other words, the twenty-two cutting blades 62 are formed in an approximately similar trapezoidal shape where only their blade-tip heights h1 are different, when viewed from the cutting direction Lc.

The twenty-two cutting blades 62 is divided into a group positioned in a first range Ra and another group positioned in a second range Rb. Herein, the first range Ra is located on a leading side of the direction opposite to the cutting direction Lc, and the second range Rb is located on a leading side of the cutting direction Lc. The number of cutting blades 62 belonging to the group positioned in the first range Ra is less than a half of a total number of the twenty-two cutting blades 62. Hereafter, the blade-tip height h1 will be described specifically.

First, the number of cutting blades 62 belonging to the group positioned in the first range Ra is three or more and five or less. In the present embodiment, as shown in FIG. 5, the three cutting blades 62, i.e., the twentieth cutting blade 62, the twenty-first cutting blade 62, and the twenty-second cutting blade 62, are located in the first range Ra.

Meanwhile, the number of cutting blades 62 belonging to the group positioned in the second range Rb is the half of the total number of the twenty-two cutting blades 62 or more. In the present embodiment, as shown in FIG. 5, the nineteen cutting blades 62, i.e., the first cutting blade 62 through the nineteenth cutting blade 62, are located in the second range Rb.

An increasing degree of the blade-tip heights h1 of the adjacent cutting blades 62 is configured to be different between the cutting blades 62 belonging to the group positioned in the first range Ra and the cutting blades 62 belonging to the group positioned in the second range Rb as shown in FIG. 8.

Specifically, as shown in FIG. 8. the increasing degree of the blade-tip heights h1 of the adjacent cutting blades 62 belonging to the group positioned in the first range Ra is set to be a constant value α. Meanwhile, as shown in FIG. 8. the increasing degree of the blade-tip heights h1 of the adjacent cutting blades 62 belonging to the group positioned in the second range Rb is set to be a constant value β.

Herein, it is set, as shown in FIG. 8, such that the above-described constant value, i.e., the increasing degree β, is greater than the above-described constant value, i.e., the increasing degree α. In other words, the cutting blades 62 belonging to the group positioned in the first range Ra are configured such that the increasing degree α of the blade-tip heights h1 of their adjacent cutting blades 62 is smaller than the increasing degree β of the blade-tip heights h1 of the adjacent cutting blades 62 belonging to the group positioned in the second range Rb as shown in FIG. 8.

Further, the finishing blade 7 is made of a higher-hardness material than the rough-machining blade 6, which is a tip blade formed by a single cutting blade only. This finishing blade 7 is formed separately from the support member 5 and the rough-machining blade 6, which is fixed to the second cutting-blade attachment part 521 of the support member 5 by an appropriate method.

Specifically, as shown in FIGS. 6 and 7, the finishing blade 7 has a top portion (apex) which is located above the twenty-second cutting blade 62, when viewed from the cutting direction Lc, which is formed in a nearly triangular shape which has substantially the same size as the substantially V-groove shaped breaking promotion portion N.

That is, the finishing blade 7 is configured, as shown in FIG. 5, such that a blade-tip height h2 of its blade tip from the bottom face 511a of the first cutting-blade attachment part 511 of the support member 5 is higher than the blade-tip height h1 of the twenty-second cutting blade 62.

More specifically, as shown in FIGS. 6 and 7, the finishing blade 7 is formed in the nearly triangular shape, when viewed from the cutting direction Lc, such that it has a lower side which has substantially the same length as the groove width W of the breaking promotion portion N, the blade-tip height h2 which is substantially the same as the groove depth H of the breaking promotion portion N, and a pair of oblique sides which substantially match the pair of oblique surfaces of the breaking promotion portion N.

As described above, the grooving tool 3 is a tool to form the substantially V-groove shaped breaking promotion portion N for breaking and splitting the large end part 13 of the connecting rod 1 at the large end part 13 along the cutting direction Lc. This grooving tool 3 comprises the rough-machining blade 6 to cut the peripheral surface of the penetrating hole 13a provided at the large end part 13, the finishing blade 7 to finish a portion cut by the rough-machining blade 6, and the support member 5 supporting the rough-machining blade 6 and the finishing blade 7 in order along the direction opposite to the cutting direction Lc.

Further, the rough-machining blade 6 is configured such that its blade-tip height h1 from the bottom face 511a of the first cutting-blade attachment portion 511 is lower the blade-tip height h2 of the finishing blade 7. Meanwhile, the finishing blade 7 is made of the higher hardness material than the rough-machining blade 6.

According to the present invention, the wear resistance of the cutting blade can be improved and the properly-sharp substantially V-groove shaped breaking promotion portion can be formed stably. Specifically, the grooving tool 3 for the connecting rod 1 is provided with the finishing blade 7 for finishing and thereby the cutting amount of the finishing blade 7 can be reduced by the rough-machining blade 6, so that a load applied to the tip of the finishing blade 7 can be suppressed. Herein, since the finishing blade 7 is made of the higher-hardness material, the wear of the finishing blade 7 can be effectively suppressed.

Additionally, since the blade-tip height h1 of the rough-machining blade 6 is lower than the blade-tip height h2 of the finishing blade 7, the rough-machining blade 6 can be used as a cutting blade for performing rough machining against the peripheral surface of the penetrating hole 13a provided at the large end part 13 of the connecting rod 1. Accordingly, it is not necessary that the blade tip of the rough-machining blade 6 is configured to be of a taper shape according to the substantially V-groove shaped breaking promotion portion N, but the rough-machining blade 6 can be of the substantially-trapezoidal shape, when viewed from the cutting direction Lc.

Thus, the grooving tool 3 for the connecting rod 1 can reduce the cutting amount of the rough-machining blade 6 properly, compared to the rough-machining blade having the taper-shaped blade tip according to the substantially V-groove shaped breaking promotion portion N, thereby suppressing the load applied to the blade tip of the rough-machining blade 6. Thus, the grooving tool 3 for the connecting rod 1 can improve the wear resistance of the cutting blade and form the properly-sharp substantially V-groove shaped breaking promotion portion N stably.

Further, the rough-machining blade 6 comprises the plural cutting blades 62 having the different blade-tip heights h1 which become gradually higher along the direction opposite to the cutting direction Lc. According to this structure, the grooving tool 3 for the connecting rod 1 can cut the peripheral surface of the penetrating hole 13a provided at the large end part 13 of the connecting rod 1 stepwise by means of the plural cutting blades 62.

Accordingly, the grooving tool 3 for the connecting rod 1 can reduce the cutting amount of each of the plural cutting blades 62 properly, compared to a case where the peripheral surface of the penetrating hole 13 by means of a single cutting blade. Thereby, the load applied to the blade tip of each of the plural cutting blades 62 can be suppressed. Thus, the grooving tool 3 for the connecting rod 1 can further improve the wear resistance of the rough-machining blade 6.

Further, the blade-tip heights h1 of the cutting blades 62 belonging to the group positioned in the second range Rb are configured such that the increasing degree β of the blade-tip heights h1 of the adjacent cutting blades 62 located on the leading side of the cutting direction Lc is substantially constant. Meanwhile, the blade-tip heights h1 of the cutting blades 62 belonging to the group positioned in the first range Ra are configured such that the increasing degree α of the blade-tip heights h1 of the adjacent cutting blades 62 located on the leading side of the cutting direction Lc is smaller than the increasing degree β of the blade-tip heights h1 of the adjacent cutting blades 62 belonging to the group positioned in the second range Rb.

According to this structure, the cutting amount of each of the cutting blades 62 belonging to the group positioned in the first range Ra can be reduced properly, compared to a case where the increasing degree α of the blade-tip heights h1 of the adjacent cutting blades 62 belonging to the group positioned in the first range Ra is the same as the increasing degree β of the blade-tip heights h1 of the adjacent cutting blades 62 belonging to the group positioned in the second range Rb. Thereby, the load applied to the taper-shaped cutting blades 62 belonging to the group positioned in the first range Ra can be properly suppressed, compared to the cutting blades 62 belonging to the group positioned in the second range Rb.

Moreover, since the load applied to the taper-shaped cutting blades 62 belonging to the group positioned in the first range Ra is properly suppressed, the grooving tool 3 for the connecting rod 1 can suppress an improper increase of the cutting amount of the finishing blade 7, which may be caused by the wear of the rough-machining blade 6, for a long term even if this grooving tool 3 is used frequently. Accordingly, the grooving tool 3 for the connecting rod 1 can further improve the wear resistance of the rough-machining blade 6 and the finishing blade 7.

Also, the rough-machining blade 6 is made of the high-speed tool steel, and the finishing blade 7 is made of the cemented carbide. According to this structure, the grooving tool 3 for the connecting rod 1 can form the properly-sharp substantially V-groove breaking promotion portion N further stably by means of the finishing blade 7 having the higher hardness than the rough-machining blade 6.

Moreover, since the cutting amount of the finishing blade 7 is reduced by the rough-machining blade 6, the wear of the finishing blade 7 can be suppressed further securely even if the finishing blade 7 is made of the cemented carbide which has the inferior toughness, compared to the high-speed tool steel. Accordingly, the grooving tool 3 for the connecting rod 1 can securely improve the wear resistance of the finishing blade 7.

Further, the breaking-promotion-portion forming device 2 comprises the above-described grooving tool 3 for the connecting rod 1, wherein the breaking-promotion-portion forming device 2 further comprises the automatic machine tool 4 which comprises the work holding section 42 to hold the large end part 13 of the connecting rod 1 and the tool holding section 43 to hold the grooving tool 3 for the connecting rod 1, the work holding section 42 and the tool holding section 43 being provided to face each other, and the breaking-promotion-portion forming device 2 is configured to form the breaking promotion portion N at the large end part 13 of the connecting rod 1 by once (one time) reciprocating the work holding section 42 along the cutting direction Lc. According to the present invention, the breaking-promotion-portion forming device 2 of the connecting rod 1 can improve the wear resistance of the cutting blade and form the properly-sharp substantially V-groove shaped breaking promotion portion N stably.

Moreover, the cutting blades 62 are formed in an approximately similar pyramid shape such that the respective lower sides have substantially the same length, when viewed from the cutting direction Lc. Thereby, the grooving tool 3 for the connecting rod 1 can reduce the cutting amount of the cutting blades 62 securely such that a degree of the cutting amount reduced by the cutting blade 62 which is positioned on the opposite side to the cutting direction Lc becomes larger.

In correspondence relationships between the present invention and the above-described embodiment, the first cutting blade of the present invention corresponds to the rough-machining blade 6 of the embodiment. Likewise, the second cutting blade corresponds to the finishing blade 7, the specified level point of the support member corresponds to the bottom face 511a of the first cutting blade attachment portion 511 of the support member 5, the specified range corresponds to the second range Rb, the other range than the specified range corresponds to the first range Ra, and the machine tool corresponds to the automatic machine tool 4. However, the present invention should not be limited to the above-described embodiment and any other modifications or improvements may be applied within the scope of a spirit of the present invention.

For example, while the breaking-promotion-portion forming device 2 of the above-described embodiment is configured such that the work holding section 42 approaches to the tool holding section 43, this breaking-promotion-portion forming device may be configured to form the breaking promotion portion N at the connecting rod 1 by one-time approaching of the tool holding section 43 to the work holding section 42.

Further, while the above-described embodiment is configured such that the approaching direction of the grooving tool 3 to the large end part 13 of the connecting rod 1 is set to be the cutting direction Lc and the grooving tool 3 forms the breaking promotion portion N by pushing/pulling process, it may be configured such that the separation direction of the grooving tool 3 from the large end part 13 of the connecting rod 1 is set to be the cutting direction and the grooving tool 3 forms the breaking promotion portion N by pulling process.

In this case, the rough-machining blade is configured to cut the peripheral surface of the penetrating hole 13a at the large end part 13 of the connecting rod 1 along the longitudinal direction L which is directed toward the held portion 53 from the first fixing portion 51 of the support member 5. Further, the cutting blades of the rough-machining blade are configured such that the blade-tip heights become gradually higher as it goes toward the opposite direction to the cutting direction (the direction which is directed toward the first fixing portion 51 from the held portion 53 in the longitudinal direction L).

Also, while the bottom face 511a of the first cutting-blade attachment portion 511 is set to be a standard face of the blade-tip heights h1, h2 in the above-described embodiment, an axial center of the support member 5, an upper end of the first fixing portion 51 of the support member 5, when viewed from the short-length direction T, the blade-groove bottom, or the like may be used as the above-described standard face.

Moreover, while the support member 5 and the rough-machining blade 6 of the above-described embodiment are configured to be separated from each other, these may be formed integrally. While the support member 5 and the finishing blade 7 are configured to be separated from each other, these may be formed integrally as well. Additionally, while the finishing blade 7 is fixed to the second fixing portion 52 of the support member 5, the finishing blade may be fixed to the first fixing portion or the finishing blade may be fixed to the rough-machining blade.

What is claimed is:

1. A grooving tool for a connecting rod which is configured to form a substantially V-groove shaped breaking promotion portion for breaking and splitting a large end part of the connection rod at the large end part along a cutting direction, comprising:
a first cutting blade to cut a peripheral surface of a penetrating hole provided at the large end part of the connecting rod;
a second cutting blade to finish a portion cut by the first cutting blade; and
a support member supporting the first cutting blade and the second cutting blade in order along a direction opposite to the cutting direction,
wherein said first cutting blade is configured such that a height of a blade tip thereof from a specified level point of said support member which is substantially parallel to said cutting direction is lower than that of said second cutting blade, and the second cutting blade is made of a higher-hardness material than the first cutting blade.

2. The grooving tool for the connecting rod of claim 1, wherein said first cutting blade comprises plural cutting blades having different blade-tip heights which become gradually higher along said direction opposite to the cutting direction.

3. The grooving tool for the connecting rod of claim 2, wherein said plural cutting blades of the first cutting blade is divided into a group positioned in a specified range and another group positioned in another range than said specified range, said specified range is located on a leading side of said cutting direction such that a cutting blade positioned at the most leading side is included in the group positioned in the specified range, the number of cutting blades belonging to the group positioned in the specified range is at least a half of a total number of the plural cutting blades of the first cutting blade or more, said blade-tip heights of the cutting blades belonging to the group positioned in said specified range are configured such that an increasing degree of the blade-tip heights of the adjacent cutting blades located on the leading side of the cutting direction is substantially constant, and said blade-tip heights of the cutting blades belonging to the group positioned in said other range than the specified range are configured such that an increasing degree of the blade-tip heights of the adjacent cutting blades located on the leading side of the cutting direction is smaller than said increasing degree of the blade-tip heights of the adjacent cutting blades belonging to the group positioned in the specified range.

4. The grooving tool for the connecting rod of claim 3, wherein said first cutting blade is made of high-speed tool steel, and said second cutting blade is made of cemented carbide.

5. A breaking-promotion-portion forming device of the connecting rod which comprises the grooving tool for the connecting rod of claim 4, wherein said breaking-promotion-portion forming device further comprises a machine tool which comprises a work holding section to hold the large end part of the connecting rod and a tool holding section to hold the grooving tool for the connecting rod, said work holding section and said tool holding section being provided to face each other, and said breaking-promotion-portion forming device is configured to form said breaking promotion portion at the large end part of the connecting rod by once reciprocating any one of said work holding section and said tool holding section of the machine tool along the cutting direction.

6. The grooving tool for the connecting rod of claim 1, wherein said first cutting blade is made of high-speed tool steel, and said second cutting blade is made of cemented carbide.

7. A breaking-promotion-portion forming device of the connecting rod which comprises the grooving tool for the connecting rod of claim 1, wherein said breaking-promotion-portion forming device further comprises a machine tool which comprises a work holding section to hold the large end part of the connecting rod and a tool holding section to hold the grooving tool for the connecting rod, said work holding section and said tool holding section being provided to face each other, and said breaking-promotion-portion forming device is configured to form said breaking promotion portion at the large end part of the connecting rod by once reciprocating any one of said work holding section and said tool holding section of the machine tool along the cutting direction.

8. The grooving tool for the connecting rod of claim 2, wherein said first cutting blade is made of high-speed tool steel, and said second cutting blade is made of cemented carbide.

9. A breaking-promotion-portion forming device of the connecting rod which comprises the grooving tool for the connecting rod of claim 2, wherein said breaking-promotion-portion forming device further comprises a machine tool which comprises a work holding section to hold the large end part of the connecting rod and a tool holding section to hold the grooving tool for the connecting rod, said work holding section and said tool holding section being provided to face each other, and said breaking-promotion-portion forming device is configured to form said breaking promotion portion at the large end part of the connecting rod by once reciprocating any one of said work holding section and said tool holding section of the machine tool along the cutting direction.

10. A breaking-promotion-portion forming device of the connecting rod which comprises the grooving tool for the connecting rod of claim 3, wherein said breaking-promotion-portion forming device further comprises a machine tool which comprises a work holding section to hold the large end part of the connecting rod and a tool holding section to hold the grooving tool for the connecting rod, said work holding section and said tool holding section being provided to face each other, and said breaking-promotion-portion forming device is configured to form said breaking promotion portion at the large end part of the connecting rod by once reciprocating any one of said work holding section and said tool holding section of the machine tool along the cutting direction.

11. A breaking-promotion-portion forming device of the connecting rod which comprises the grooving tool for the connecting rod of claim 7, wherein said breaking-promotion-portion forming device further comprises a machine tool which comprises a work holding section to hold the large end part of the connecting rod and a tool holding section to hold the grooving tool for the connecting rod, said work holding section and said tool holding section being provided to face each other, and said breaking-promotion-portion forming device is configured to form said breaking promotion portion at the large end part of the connecting rod by once reciprocating any one of said work holding section and said tool holding section of the machine tool along the cutting direction.

12. A breaking-promotion-portion forming device of the connecting rod which comprises the grooving tool for the connecting rod of claim 9, wherein said breaking-promotion-portion forming device further comprises a machine tool which comprises a work holding section to hold the large end part of the connecting rod and a tool holding section to hold the grooving tool for the connecting rod, said work holding section and said tool holding section being provided to face each other, and said breaking-promotion-portion forming device is configured to form said breaking promotion portion at the large end part of the connecting rod by once reciprocating any one of said work holding section and said tool holding section of the machine tool along the cutting direction.
